(19) United States
(12) Patent Application Publication
(10) Pub. No.: US 2019/0108273 A1
(43) Pub. Date: Apr. 11, 2019

(54) Data Processing Method, Apparatus and Electronic Device

(71) Applicant: Alibaba Group Holding Limited, Grand Cayman (KY)

(72) Inventors: Sheng Li, Hangzhou (CN); Chen Wu, Hangzhou (CN); Jiangnan Xia, Hangzhou (CN)

(21) Appl. No.: 16/155,800

(22) Filed: Oct. 9, 2018

(30) Foreign Application Priority Data
Oct. 10, 2017 (CN) 201710936227.0

(51) Int. Cl. G06F 17/30; G06N 5/00

(52) U.S. Cl. CPC G06F 17/30654; G06F 17/3043; G06N 5/00; G06F 17/30616; G06F 17/30705; G06F 17/30622

(57) ABSTRACT

A data processing method, an apparatus, and an electronic device are provided by the embodiments of the present disclosure. The method includes obtaining questions for an application environment; separately inputting the questions into a plurality of different types of question-and-answer models for processing to generate respective intermediate answers corresponding to each model, wherein the plurality of different types of question-and-answer models separately possess model data conforming to respective data forms, the model data is any number of pieces of structured data, semi-structured data, and unstructured data; and processing the intermediate answers generated for each model to generate and output a final answer based on a preset answer output strategy. By using any models of a knowledge map model, a FAQ model and a machine reading comprehension model in a comprehensive manner, the embodiments of the present disclosure generate answers, and complement advantages of a plurality of types of models, thus overcoming biases and errors caused by a single model, and improving the accuracy and comprehensiveness of the answers.

### CROSS REFERENCE TO RELATED PATENT APPLICATIONS

This application claims priority to Chinese Patent Application No. 201710936227.0, filed on 10 Oct. 2017, entitled “Data Processing Method, Apparatus and Electronic Device,” which is hereby incorporated by reference in its entirety.

### TECHNICAL FIELD

The present disclosure relates to the technical field of computers, and particularly, to data processing methods, apparatuses, and electronic devices.

### BACKGROUND

In current automatic question-and-answer technologies, the FAQ (Frequently Asked Question) technology, which obtains candidate questions similar to a target question using a method of retrieving question-and-answer pairs, and outputs answers of the candidate questions as an answer to the target question, is relatively commonly seen. For a method of retrieving question-and-answer pairs, on the one hand, the question-and-answer question pairs need to be manually refined and collected, which is very cumbersome. For example, questions in the news, encyclopedia, and business documents are successively listed, and answers are then manually written. On the other hand, it is often only possible to enumerate highly frequent questions, and a long tail type of questions and answers is not well covered.

With the rise of knowledge bases and the introduction of structured query technologies, a method of retrieving questions and answers based on a knowledge map is gradually applied to automatic question-and-answer technology. Questions and answers that are automatically constructed based on a knowledge map first needs to undergo through an entire set of knowledge engineering methods, such as entity detection, entity link, attribute filling, etc., to construct a structured knowledge map from texts, and perform questions and answers on a basis of the knowledge map. The entire process is cumbersome.

In recent years, with applications of deep learning in NLP (Nature Language Processing), machine reading comprehension has also been gradually adopted as a technique of the automatic question-and-answer technology. Machine reading comprehension reduces manual extraction or organization tasks in an early stage to a certain extent, and an end-to-end training also reduces errors introduced by multi-stage processing. However, the impact of the performance due to locating a chapter used for answering a question and long chapters will also greatly reduce the accuracy.

In short, in existing technologies, the above three automatic question-and-answer technologies have their own advantages and disadvantages, and cannot meet the needs of increasingly complex automatic question-and-answer environments.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or processor-readable/computer-readable instructions as permitted by the context above and throughout the present disclosure.

The embodiments of the present disclosure provides data processing methods, apparatuses and electronic devices, which effectively combine characteristics of multiple automatic question-and-answer models, and realizes complementary advantages to cope with complicated automatic question-and-answer environments.

In order to achieve the above objectives, the embodiments of the present disclosure adopt the following technical solutions.

In implementations, a data processing method is provided, which includes obtaining questions for an application environment; separately inputting the questions into a plurality of different types of question-and-answer models for processing to generate respective intermediate answers corresponding to each model, wherein the plurality of different types of question-and-answer models separately possess model data conforming to respective data forms, the model data is any number of pieces of structured data, semi-structured data, and unstructured data; and processing the intermediate answers generated for each model to generate and output a final answer based on a preset answer output strategy.

In implementations, a data processing method is provided, which includes obtaining first text data in the application environment, classifying the first text data, and extracting any number of pieces of data in the structured data, the semi-structured data, and the unstructured data; and separately processing the any number of pieces of data in the structured data, the semi-structured data, and the unstructured data according to data format requirements of appropriate question-and-answer models to generate the model data of each model and storing the model data of each model.

In implementations, a data processing apparatus is provided, which includes a question acquisition module configured to obtain questions for an application environment; a model processing module configured to separately input the questions into a plurality of different types of question-and-answer models for processing to generate respective intermediate answers corresponding to each model, wherein the plurality of different types of question-and-answer models separately possess model data conforming to respective data forms, the model data is any number of pieces of structured data, semi-structured data, and unstructured data; and an answer output module configured to process the intermediate answers generated for each model to generate and output a final answer based on a preset answer output strategy.

In implementations, a data processing apparatus is provided, which includes an environment text acquisition module configured to obtain first text data in the application environment, classifying the first text data, and extracting any number of pieces of data in the structured data, the semi-structured data, and the unstructured data; and a model data generation module configured to separately process the any number of pieces of data in the structured data, the semi-structured data, and the unstructured data according to data format requirements of appropriate question-and-answer models to generate the model data of each model and store the model data of each model.

In implementations, an electronic device is provided, which includes memory configured to store a program; and processor(s) coupled to the memory and configured to execute the program for obtaining questions for an application environment; separately inputting the questions into a plurality of different types of question-and-answer models for processing to generate respective intermediate answers corresponding to each model, wherein the plurality of different types of question-and-answer models separately possess model data conforming to respective data forms, the model data is any number of pieces of structured data, semi-structured data, and unstructured data; and processing the intermediate answers generated for each model to generate and output a final answer based on a preset answer output strategy.

In implementations, an electronic device is provided, which includes memory configured to store a program; and processor(s) coupled to the memory and configured to execute the program for obtaining first text data in the application environment, classifying the first text data, and extracting any number of pieces of data in the structured data, the semi-structured data, and the unstructured data; and separately processing the any number of pieces of data in the structured data, the semi-structured data, and the unstructured data according to data format requirements of appropriate question-and-answer models to generate the model data of each model and storing the model data of each model.

The data processing methods, apparatuses and electronic devices of the embodiments of the present disclosure generate answers by using a plurality of question-and-answer models in combination, and complement advantages of the plurality of models, thus overcoming biases and errors caused by a single model, and improving the accuracy and comprehensiveness of the answers.

The above description is only an overview of technical solutions of the present disclosure. In order to enable a clearer understanding of technical schemes of the present disclosure and allow implementations according to content of the specification, particular embodiments of the present disclosure are set forth herein for better understanding of the above and other goals, features and advantages of the present disclosure.

### BRIEF DESCRIPTION OF THE DRAWINGS

FIG. 1 is a schematic structural diagram of a data processing system in accordance with the embodiments of the present disclosure.

FIG. 2 is a flowchart of a first data processing method in accordance with the embodiments of the present disclosure.

FIG. 3 is a flowchart of a second data processing method in accordance with the embodiments of the present disclosure.

FIG. 4 is a schematic structural diagram of a first data processing apparatus in accordance with the embodiments of the present disclosure.

FIG. 5 is a schematic structural diagram of a second data processing apparatus in accordance with the embodiments of the present disclosure.

FIG. 6 is a schematic structural diagram of a first electronic device in accordance with the embodiments of the present disclosure.

FIG. 7 is a schematic structural diagram of a second electronic device in accordance with the embodiments of the present disclosure.

### DETAILED DESCRIPTION

Exemplary embodiments of the present disclosure will be described in more detail hereinafter with reference to accompanying drawings. Although the exemplary embodiments of the present disclosure are shown in the accompanying drawings, it should be understood that the present disclosure can be implemented in various forms and should not be limited by the embodiments disclosed herein. Rather, these embodiments are provided so that the present disclosure can be understood in a more comprehensive manner, and the scope of the disclosure can be conveyed fully to one skilled in the art.

Explanation of Terminologies:

FAQ: Frequently Asked Question

Automated Q&A: Automated Q&A is an important direction in the field of natural language processing, and is designed to allow users to ask questions and get answers directly in natural language.

Machine reading comprehension: An automatic question-and-answer technique designed to let a machine read a text and automatically answer questions based on the meaning of the text that is comprehended.

Knowledge map: A semantic network interconnected by knowledge points, and commonly used for knowledge reasoning and automatic answering to questions.

The technical principles of the embodiments of the present disclosure are to organically combine a knowledge map model, a FAQ model, and a machine reading comprehension model, so that each model separately processes structured data, semi-structured data, and unstructured data on which respective advantages can be exerted. Intermediate answers outputted from each model are selected or evaluated using a certain strategy, and a more preferred intermediate answer is selected for output, so that complementary advantages are formed for various models, which can cope with more complicated application environments and improve the accuracy and comprehensiveness of answers.

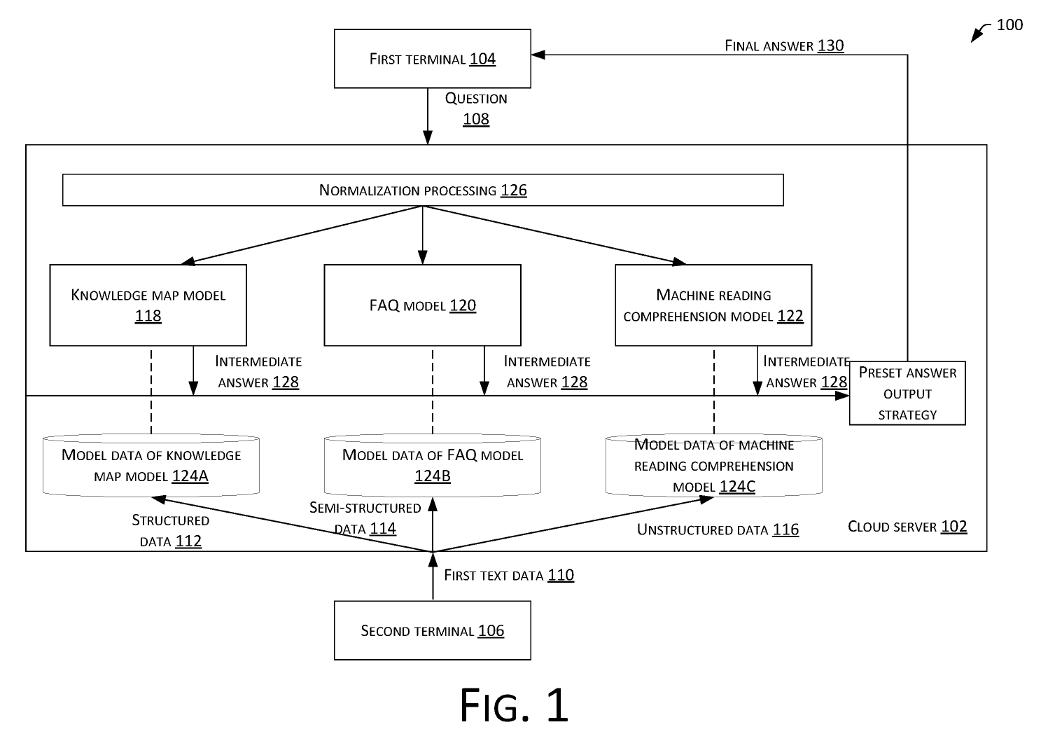

FIG. 1 is a schematic structural diagram of a data processing system 100 according to the embodiments of the present disclosure. The system is an example in reality, which includes a server 102 in a cloud, a first terminal 104 and a second terminal 106. A data processing part of automated Q&A may be set in the server 102 in the cloud. The server 102 is connected to the first terminal 104 and the second terminal 106. The first terminal 104 is configured to input a question 108 to the server 102, and the second terminal 106 is configured to input first text data 110 related to the application environment to the server 102. Apparently, in practical applications, the first terminal 104 and the second terminal 106 may also be the same terminal. The application environment described herein refers to a scope of information for the automated Q&A. For example, the application environment may be a general conference, and data of the conference relates to an agenda of the conference, participants, content of the conference, and the like. For another example, the application environment may be Information about a certain historical monument, etc. An automatic question-and-answer data processing system for such application environments is constructed, thereby serving users who ask questions for these application environments. Apparently, the above application environments may also involve a wider scope of information. Accordingly, in a process of constructing the data processing system, more first text data related to application environment(s) may be inputted.

In the server 102, the data processing system includes two aspects of data processing functions, which are detailed as follows.

A First Aspect: Preparation of Model Data (A Data Process from Bottom to Top in the Figure)

The second terminal 106 inputs the first text data 110 related to the application environment to the server 102 in the cloud. The data processing system in the server 102 classifies the first text data 110 in the application environment, and extracts structured data 112, semi-structured data 114, and unstructured data 116.

The above three types of data are then processed according to data form requirements of appropriate question and answer models, and may be allocated to a knowledge map model 118, a FAQ model 120 and a machine reading comprehension model 122 for processing to generate model data 124A-C of various models according to the embodiments of the present disclosure. These pieces of model data are stored in a database corresponding to each model. These pieces of model data are data foundation that supports subsequent automated Q&A.

A Second Aspect: Generation of an Answer to an Input Question 108 (A Process from Top to Bottom in the Figure)

A user inputs a question related to an application scenario to the server 102 in the cloud through the first terminal. After performing normalization processing 126 on the input question 108, the data processing system in the server 102 separately inputs thereof into the above-mentioned question-and-answer models suitable for processing structured data, semi-structured data and unstructured data, and can be inputted into a knowledge map model, a FAQ model and a machine reading comprehension model according to the embodiments of the present disclosure. A process of normalization process 126 described herein refers to a text filtering process that does not affect semantics, e.g., removing spaces from a text of the input question, converting traditional Chinese into simplified Chinese, changing between English uppercases and lowercases, removing meaningless characters, etc., to allow a format of a unified specification, which can be adapted to the above three types of models.

The above three types of models then perform question searching and processing on the input question, and output respective answers separately. In the embodiments of the present disclosure, answer(s) outputted by each model is/are referred to as intermediate answer(s) 128. The data processing system performs processing, such as screening, evaluation or combination, etc., on intermediate answers 128 obtained by various models according to a predetermined answer output strategy to obtain a final answer 130, and provides the final answer to the user through the first terminal. The predetermined answer output strategy described above can adopt the following three strategies.

Greedy strategy: Answers outputted from all the models are outputted as final answers.

Optimal strategy: Answers outputted from various models are scored based on credibility, and an answer having the highest score is outputted.

Integration strategy: A portion having the highest coverage rate in texts of the answers that are returned is selected as a final answer for output, i.e., a part having the highest repetition rate (content having the highest degree of overlapping among mutual content) in each answer is extracted to form the final answer.

Using the above three strategies, a final answer that meets the user's needs can be provided according to different needs.

Through the data processing system of the present embodiment, the knowledge map model, the FAQ model, and the machine reading comprehension model are comprehensively utilized to perform data processing for automatic Q&A based on structured data, semi-structured data, and unstructured data respectively. Processing advantages of each model for different types of data are fully manifested, and intermediate answers generated by each model are obtained. The intermediate answers are processed, for example, filtered, evaluated or combined according to a predetermined strategy, thereby obtaining a more preferable final answer for output. This type of processing system overcomes biases and errors caused by a single model in existing technologies, improving the accuracy and comprehensiveness of the answer.

It should be noted that, in the embodiments of the present disclosure, any two models among the knowledge map model, the FAQ model, and the machine reading comprehension model may be used for comprehensive processing, and effects thereof also possess technical effects that are constructive to the existing technologies. For the sake of description, technical solutions of the present disclosure are described in the following embodiments through an example of simultaneously using three models.

### First Embodiment

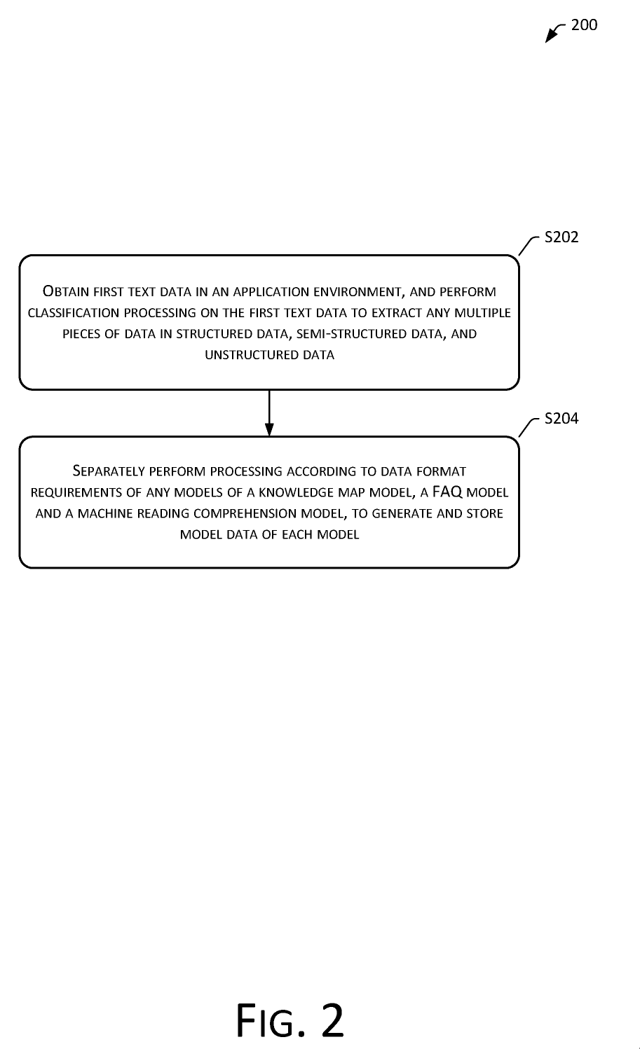

FIG. 2 shows a flowchart of a first data processing method 200 according to the embodiments of the present disclosure. The data processing method 200 relates to aforementioned preparation work of model data, which may include the following operations.

S202: Obtain first text data in an application environment, and perform classification processing on the first text data to extract any multiple pieces of data in structured data, semi-structured data, and unstructured data.

As mentioned above, the application environment is actually a scope of information, and the automatic question-and answer-technology often configures and processes data for a specific application environment. A conference manual of a conference is taken as an example of the first text data. Tabular data (a form such as a conference agenda) is structured data. Frequently Asked Questions (FAQ) in the conference manual are semi-structured data. FAQ data is presented as a form of question/answer pairs of questions and answers, and the questions and answers are described in natural language. Descriptive text in the conference manual (such as briefings, guest profiles, etc.) is unstructured data.

In this type of application scenario, the conference manual is inputted as the first text data of the application environment, and the content in the conference manual is then classified and extracted to form the structured data, semi-structured data, and unstructured data as described above.

For example, in scenarios such as museums, art galleries, and tourist areas, etc., visitors often have many questions about the venues themselves, the art, and the history and culture of the tourist areas, etc. Among information about the museums, the art galleries and the tourist areas, some common and historically accumulated questions exist, such as how much a ticket costs, how to buy a ticket, what the opening and closing times are, etc. These belong to FAQ data. At the same time, a lot of structured information exists, for example, names, ages, authors, etc. of artwork themselves, names and ages of construction of ancient buildings, etc. These belong to structured data. In addition, a descriptive text is also included therewith, such as an overall introduction of a venue, the history of a tourist area, etc. These belong to unstructured data.

For comprehensive scenes such as museums, art galleries and tourist areas, the above three types of data can be processed uniformly by means of a hybrid model of the embodiments of the present disclosure, and three question-and-answer models are combined to provide an automatic question-and-answer service to tourists.

S204: Separately process any multiple pieces of the structured data, the semi-structured data, and the unstructured data according to data format requirements of appropriate question-and-answer models. Specifically, in the present embodiment, any multiple pieces of the foregoing data may be processed according to data format requirements of any ones of the knowledge map model, the FAQ model and the machine reading comprehension model, to generate model data of each model for storage.

For different types of data, the three models perform different processing, and details thereof are as follows:

1) For structured data, the following processing can be performed according to data format requirements of the knowledge map model:

The structured data is processed into a knowledge base that is constructed based on a triplet format and a map structure formed by establishing relationships between entities based on attributes. A triplet herein refers to an entity, an attribute, and an attribute value. The map structure is equivalent to an index of the knowledge base. By constructing model data based on the knowledge base and the map structure, corresponding knowledge points (that is, entities in triplets as described above) can be quickly found in subsequent searches for questions.

2) For semi-structured data, the following processing can be performed according to data format requirements of the FAQ model:

Text clustering is performed on answers in the semi-structured data to obtain multiple expressions of questions in the semi-structured data. An inverted index is constructed based on the questions, and question/answer pairs having the inverted index are generated based on construction of the questions. In subsequent applications, the inverted index can be utilized according to an input question to determine all answers related to the question.

3) For unstructured data, the following processing can be performed according to data format requirements of the machine reading comprehension model:

The unstructured data is divided into a plurality of pieces of second text data according to topics and/or paragraphs, and an index is created according to the topics and/or the paragraphs. By dividing unstructured data (such as a lengthy descriptive text) into a plurality of small text portions (i.e., second text data as described above) in advance, a scope of answers is first narrowed down to the second text data through the index for the topics and/or the paragraphs in subsequent searches for questions, and the machine reading comprehension is then further used to obtain accurate answer(s). Such processing can significantly improve the efficiency of generation of the answer(s).

Using the data processing method of the present embodiment, the first text data in the application environment is classified and extracted according to the structured data, the semi-structured data, and the unstructured data, and is then pre-processed according to the data format requirements of the knowledge map model, the FAQ model, and the machine reading comprehension model, thus providing a data foundation for subsequent automated question-and-answer processing based on a combination of these three models.

### Second Embodiment

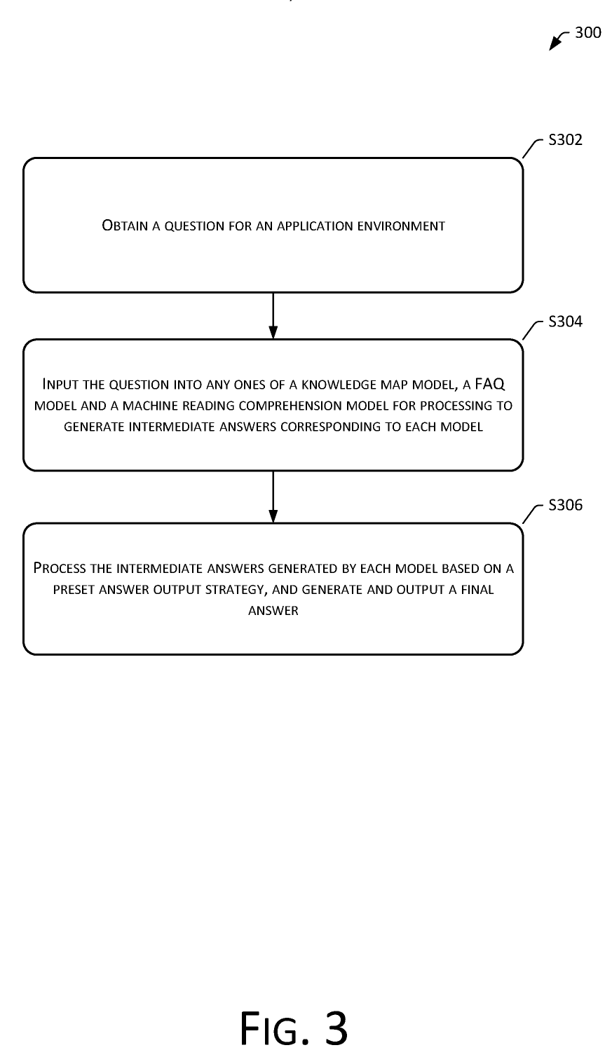

FIG. 3 shows a flowchart of a second data processing method 300 according to the embodiments of the present disclosure. The data processing method 300 relates to a process of data processing after a user inputs a question. The method 300 may be data processing of automated Q&A performed based on model data constructed according to the foregoing first embodiment. In implementations, the method 300 may include the following operations.

S302: Obtain a question for an application environment. The conference is still used as an example. A conference involves a large number of users consulting on the content of the conference and related parties around the conference. For example, “How to buy a ticket for the conference?”, “What is the topic given by a certain speaker?”, “How many data centers does Alibaba Cloud have in China?” (e.g., the content of the conference is related to cloud technology), etc.

After the question is obtained, the question may also be normalized so that the question can be adapted to input format requirements of any models from among the knowledge map model, the FAQ model, and the machine reading comprehension model.

S304: Input the question into a plurality of different types of question-and-answer models for processing to generate intermediate answers corresponding to each model, wherein the plurality of different types of question-and-answer models individually have model data conforming to respective data forms. The model data may be implemented as the first embodiment introduces and comes from extraction and processing of the first text data of the application environment. The above model data may be any multiple pieces of structured data, semi-structured data, and unstructured data.

In the present embodiment, the plurality of different types of question-and-answer models may be specifically any ones of a knowledge map model, a FAQ model, and a machine reading comprehension model. Model data of a knowledge map model is structured data. Model data of a FAQ model is semi-structured data. Model data of a machine reading comprehension model is unstructured data.

Answers to questions asked by users are generally in the conference manual mentioned above. An application of the automatic question-and-answer technology is to be capable of finding the answers automatically and efficiently and output the answers to the users. In the present embodiment, advantages of different data models can be utilized to obtain more accurate answers based on the classification processing performed on the content of the conference manual in the first embodiment.

For example, an answer to the question of “How to buy a ticket for the conference?” is generally in FAQ of the conference manual. Therefore, an answer outputted from the FAQ model is more accurate. For the question of “What is the topic given by a certain speaker?”, this part of content is covered by the knowledge map since each speaker and the topic of the speech thereof are stored in a form of a table of the conference agenda. Therefore, an answer that is outputted based on the knowledge map model is more accurate. For such question of “How many data centers does Alibaba Cloud have in China?”, an answer is generally recorded in a detailed description in the conference manual, for example, in a detailed introduction of Alibaba Cloud in the conference manual. For this question, an answer outputted by the machine reading comprehension model is more accurate.

It should be noted that each of the above models may have an answer, and may output an answer. However, due to differences between questions, only answers outputted by some of the models may be more accurate and have a higher confidence degree. In the embodiments of the present disclosure, a question that is initially inputted is inputted into various models, and a final output answer is then determined after intermediate answers outputted by the various model are collected and summarized.

Specifically, a process in which each model generates an intermediate answer based on an input question may use the following methods.

1) Processing of Knowledge Map Model

As explained above, the model data of the knowledge map model includes a knowledge base that is constructed based on a triplet format and a map structure formed by establishing relationships between entities based on attributes. Accordingly, a process of generating an intermediate answer is given as follows:

Structured processing is performed on the question to extract entity or attribute information, which is inputted into a question structured search engine in the knowledge map model for searching to obtain attribute(s) corresponding to the entity or attribute value(s) corresponding to the attribute information. Knowledge point(s) corresponding to the attribute(s) or attribute value(s) is/are used as intermediate answer(s) outputted by the knowledge map model.

2) Processing of the FAQ Model

As explained above, the model data for the FAQ model includes question/answer pairs with an inverted index that is built on questions. Accordingly, a process of generating an intermediate answer is given as follows:

The question is inputted into the FAQ model for processing. Generating an answer based on the FAQ model includes inputting the question into a FAQ question search engine in the FAQ model to search for an answer, generating an order of answers of similar questions, and selecting an answer of a similar question having the highest ranking as the answer for outputting as an intermediate answer of the FAQ model.

3) Processing of the Machine Reading Comprehension Model

As explained above, the model data of the machine reading comprehension model includes a plurality of pieces of second text data having indices according to topics and/or paragraphs. Accordingly, a process of generating an intermediate answer is given as follows:

The question is inputted into a document search engine in the machine reading comprehension model for searching. Second textual data related to the question is determined through an index of topics and/or segments. The question is then treated as an input to a process of machine reading comprehension, and machine reading processing is performed on the second text data to generate an intermediate answer as an output of the machine reading comprehension model.

S306: Process the intermediate answers generated by each model based on a preset answer output strategy, and generate and output a final answer. As mentioned earlier, the answer output strategy can take any one or more of the following three strategies:

Greedy strategy: Output multiple intermediate answers generated by each model directly as final answers. Such an output strategy can provide users with rich and comprehensive answers.

Optimal strategy: Confidence-based scoring is performed on the intermediate answers generated by each model, and an intermediate answer having the highest score is selected as a final answer for output. Such an output strategy can provide users with an answer having a higher accuracy and reduce redundant information.

Integration strategy: Coverage analysis of text content of the intermediate answers generated by each model is performed, and text content having the highest coverage rate is selected as a final answer for output. Such an output strategy maximizes the use of intermediate answers outputted from the individual models in a comprehensive manner.

Through the data processing method of the present embodiment, any number of models of the knowledge map model, the FAQ model and the machine reading comprehension model are comprehensively utilized to generate an answer, to achieve mutual complementation of the advantages of the multiple models. Finally, through a preset strategy for answer output is to screen, processing, such as screening, evaluation, or combination, etc., of the answers of various models is performed, to obtain a more optimal final answer for output, thereby overcoming biases and errors caused by a single model in the existing technologies, and improving the accuracy and comprehensiveness of the answer.

### Third Embodiment

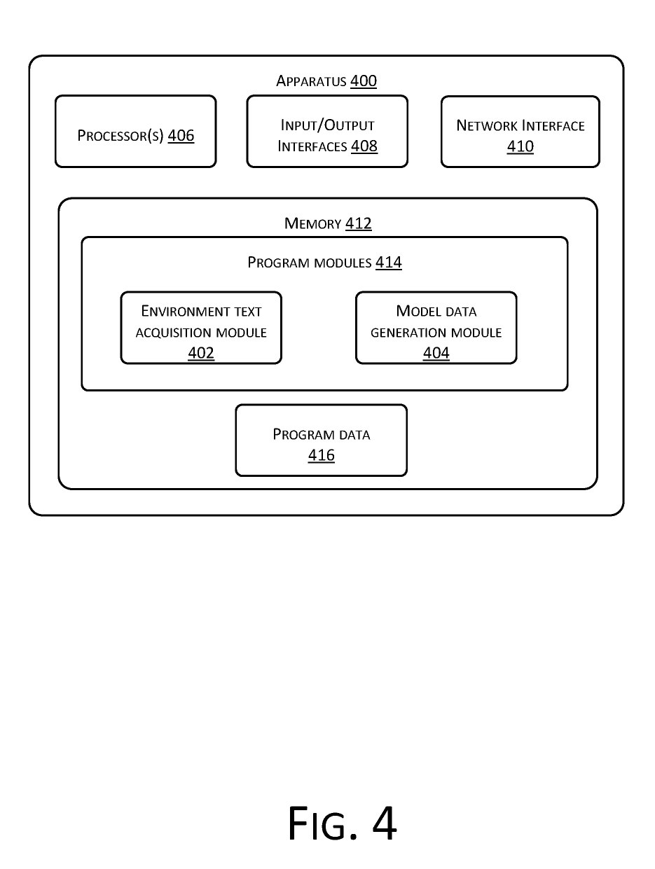

FIG. 4 shows a schematic structural diagram of a first data processing apparatus 400 according to the embodiments of the present disclosure. The data processing apparatus 400 relates to preparation work of model data. In implementations, the apparatus 400 may include one or more computing devices. In implementations, the apparatus 400 may be a part of one or more computing devices, e.g., implemented or run by the one or more computing devices. In implementations, the one or more computing devices may be located in a single place or distributed among a plurality of network devices over a network. By way of example and not limitation, the apparatus 400 may include an environment text acquisition module 402 configured to obtain first text data in the application environment, classifying the first text data, and extracting any number of pieces of data in structured data, semi-structured data, and unstructured data; and a model data generation module 404 configured to separately process the any number of pieces of data in the structured data, the semi-structured data, and the unstructured data according to data format requirements of appropriate question-and-answer models to generate the model data of each model and store the model data of each model. Specifically, any one of the structured data, the semi-structured data, and the unstructured data may be processed according to data format requirements of any multiple models of a knowledge map model, a FAQ model, and a machine reading comprehension model to generate and store model data for each model.

In implementations, the apparatus 400 may further include one or more processors 406, an input/output (I/O) interface 408, a network interface 410, and memory 412.

The memory 412 may include a form of computer readable media such as a volatile memory, a random access memory (RAM) and/or a non-volatile memory, for example, a read-only memory (ROM) or a flash RAM. The memory 412 is an example of a computer readable media.

The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In implementations, the memory 412 may include program modules 414 and program data 416. The program modules 414 may include one or more of the modules as described in the foregoing description and shown in FIG. 4.

Detailed description of content such as functions and technical effects of various functional modules involved in the data processing apparatus of the present embodiment have been fully described in the foregoing embodiments, and the content thereof is still applicable to the present embodiment. Details thereof are not repeatedly described herein.

### Fourth Embodiment

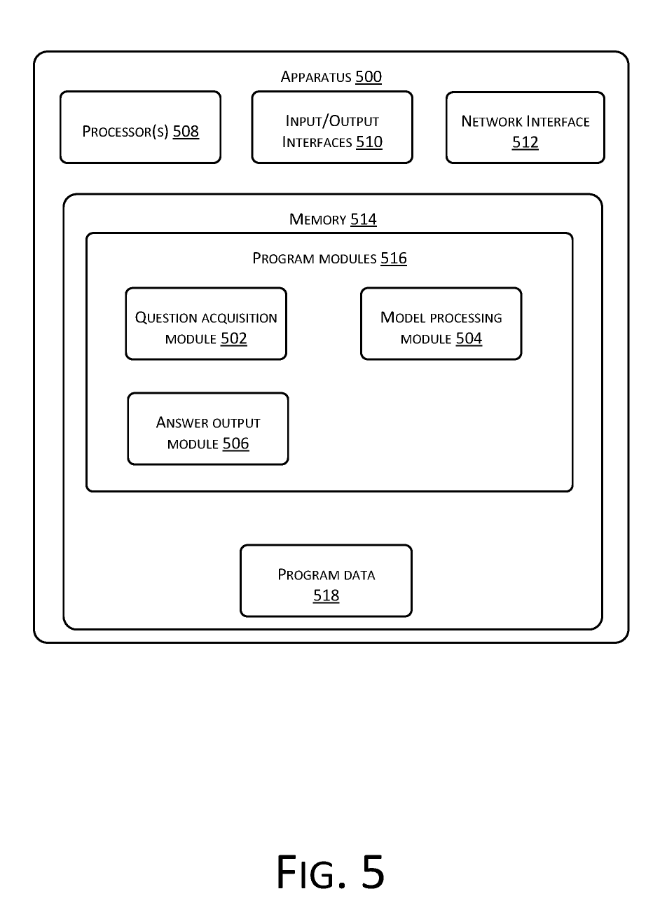

FIG. 5 shows a schematic structural diagram of a second data processing apparatus 500 according to the embodiments of the present disclosure. The data processing apparatus 500 relates to a process of data processing in an aspect of answer generation after a user inputs a question. The method may be data processing of automated Q&A performed based on model data constructed according to the foregoing first embodiment. In implementations, the apparatus 500 may include one or more computing devices. In implementations, the apparatus 500 may be a part of one or more computing devices, e.g., implemented or run by the one or more computing devices. In implementations, the one or more computing devices may be located in a single place or distributed among a plurality of network devices over a network. By way of example and not limitation, the apparatus 500 may include a question acquisition module 502 configured to obtain questions for an application environment; a model processing module 504 configured to separately input the questions into a plurality of different types of question-and-answer models for processing to generate respective intermediate answers corresponding to each model, wherein the plurality of different types of question-and-answer models separately possess model data conforming to respective data forms, the model data is any number of pieces of structured data, semi-structured data, and unstructured data, and wherein the plurality of different types of question-and-answer models may include any ones of a knowledge map model, a FAQ model, and a machine reading comprehension model, model data of the knowledge map model, being structured data, model data of the FAQ model being semi-structured data, and model data of the machine reading comprehension model being unstructured data; and an answer output module 506 configured to process the intermediate answers generated for each model to generate and output a final answer based on a preset answer output strategy.

In implementations, the apparatus 500 may further include one or more processors 508, an input/output (I/O) interface 510, a network interface 512, and memory 514.

The memory 514 may include a form of computer readable media such as a volatile memory, a random access memory (RAM) and/or a non-volatile memory, for example, a read-only memory (ROM) or a flash RAM. The memory 514 is an example of a computer readable media as described in the foregoing description.

In implementations, the memory 514 may include program modules 516 and program data 518. The program modules 516 may include one or more of the modules as described in the foregoing description and shown in FIG. 5.

Detailed description of content such as functions and technical effects of various functional modules involved in the data processing apparatus of the present embodiment have been fully described in the foregoing embodiments, and the content thereof is still applicable to the present embodiment. Details thereof are not repeatedly described herein.

### Fifth Embodiment

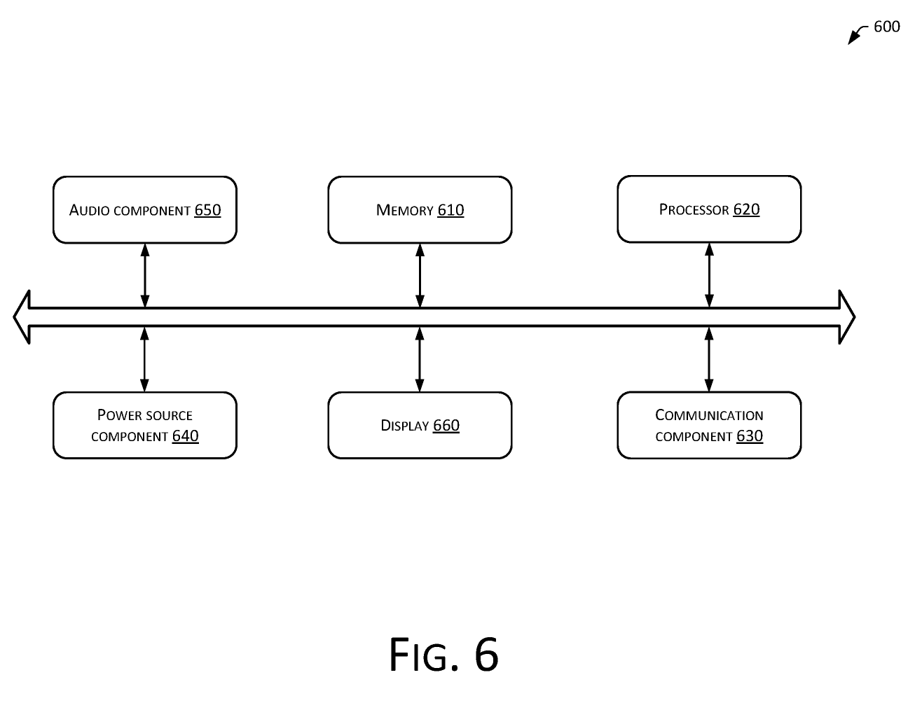

The foregoing third embodiment describes a functional structure of a data processing apparatus of the embodiments of the present disclosure in terms of an aspect of preparation work of model data, and functions of the apparatus can be implemented by an electronic device. FIG. 6 shows a schematic structural diagram of an electronic device 600 according to the embodiments of the present disclosure, which includes memory 610 and a processor 620.

The memory 610 is configured to store a program.

In addition to the above program, the memory 610 can also be configured to store various types of other data to support operations on the electronic device. Examples of such data include instructions for any application programs or methods operating on the electronic device, contact data, phonebook data, messages, pictures, videos, and the like.

The memory 610 can be implemented by any type of volatile or non-volatile storage device, or a combination thereof, such as static random access memory (SRAM), electrically erasable programmable read only memory (EEPROM), erasable programmable read only memory (EPROM), programmable read only memory (PROM), read only memory (ROM), a magnetic device, flash memory, a magnetic disk or an optical disk.

The processor 620 is coupled to the memory 610, and is configured to execute the program in the memory 610 for: obtaining first text data in an application environment, classifying the first text data, and extracting any number of pieces of data in structured data, semi-structured data, and unstructured data; and separately processing the any number of pieces of data in the structured data, the semi-structured data, and the unstructured data according to data format requirements of appropriate question-and-answer models to generate the model data of each model and storing the model data of each model.

Separately processing the any number of pieces of data in the structured data, the semi-structured data, and the unstructured data according to the data format requirements of the appropriate question-and-answer models may include: processing any pieces of data in the structured data, semi-structured data, and the unstructured data in the data according to the data format requirements of any multiple models of a knowledge map model, a FAQ model, and a machine reading comprehension model.

In addition, other functions in the above third embodiment may also be stored in the memory 610 in a form of programs, and read and executed by the processor 620. Details of a control process have been described in the third embodiment in detail, and the same applies to the present embodiment. Details thereof are not repeatedly described herein.

Furthermore, as shown in FIG. 6, the electronic device 600 may further include a communication component 630, a power source component 640, an audio component 650, a display 660, and other components. Only a portion of the components are schematically illustrated in FIG. 6, and it is not meant that the electronic device includes only the components shown in FIG. 6.

The communication component 630 is configured to facilitate wired or wireless communications between the electronic device and other devices. The electronic device can access a wireless network based on a communication standard such as WiFi, 2G or 3G, or a combination thereof. In an exemplary embodiment, the communication component 630 receives broadcast signals or broadcast related information from an external broadcast management system via a broadcast channel. In an exemplary embodiment, the communication component 630 also includes a near field communication (NFC) module to facilitate short range communication. For example, the NFC module can be implemented based on radio frequency identification (RFID) technology, infrared data association (IrDA) technology, ultra-wideband (UWB) technology, Bluetooth (BT) technology, and other technologies.

The power source component 640 provides power to various components of the electronic device. The power component 640 can include a power management system, one or more power sources, and other components associated with generating, managing, and distributing power for the electronic device.

The audio component 650 is configured to output and/or input audio signals. For example, the audio component 650 includes a microphone (MIC) that is configured to receive an external audio signal when the electronic device is in an operational mode, such as a call mode, a recording mode, and a voice recognition mode. The received audio signal may be further stored in the memory 610 or transmitted via the communication component 630. In some embodiments, the audio component 650 also includes a speaker for outputting audio signals.

The display 660 includes a screen. The screen may include a liquid crystal display (LCD) and a touch panel (TP). If the screen includes a touch panel, the screen can be implemented as a touch screen to receive input signals from a user. The touch panel includes one or more touch sensors to sense touches, swipes, and gestures on the touch panel. A touch sensor can sense not only boundaries of a touching or swiping action, but also a time duration and a pressure associated with a touching or swiping operation.

### Seventh Embodiment

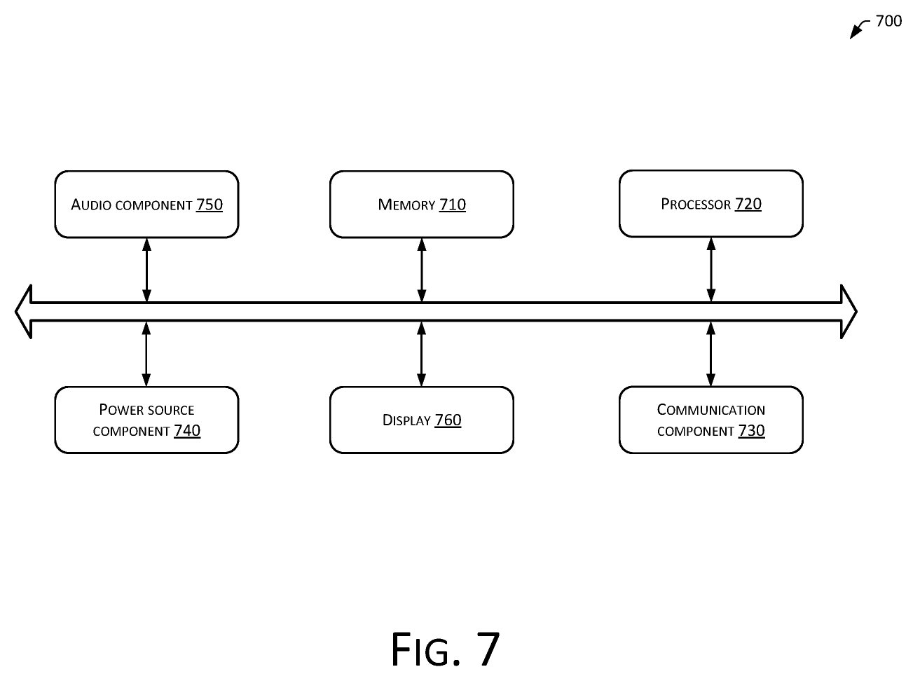

The foregoing fourth embodiment describes a functional structure of data processing of a data processing apparatus in an answer generation after a user inputs a question according to the embodiments of the present disclosure, and functions of the apparatus can be implemented using an electronic device. FIG. 7 shows a schematic structural diagram of an electronic device 700 according to the embodiments of the present disclosure, which includes memory 710 and a processor 720.

The memory 710 is configured to store a program.

In addition to the above program, the memory 710 can also be configured to store various types of other data to support operations on the electronic device. Examples of such data include instructions for any application programs or methods operating on the electronic device, contact data, phonebook data, messages, pictures, videos, and the like.

The memory 710 can be implemented by any type of volatile or non-volatile storage device, or a combination thereof, such as static random access memory (SRAM), electrically erasable programmable read only memory (EEPROM), erasable programmable read only memory (EPROM), programmable read only memory (PROM), read only memory (ROM), a magnetic device, flash memory, a magnetic disk or an optical disk.

The processor 720 is coupled to the memory 710, and is configured to execute the program in the memory 710 for: obtaining questions for an application environment; separately inputting the questions into a plurality of different types of question-and-answer models for processing to generate respective intermediate answers corresponding to each model, wherein the plurality of different types of question-and-answer models separately possess model data conforming to respective data forms, the model data is any number of pieces of structured data, semi-structured data, and unstructured data, and wherein the plurality of different types of question-and-answer models may include any ones of a knowledge map model, a FAQ model, and a machine reading comprehension model, model data of the knowledge map model, being structured data, model data of the FAQ model being semi-structured data, and model data of the machine reading comprehension model being unstructured data; and processing the intermediate answers generated for each model to generate and output a final answer based on a preset answer output strategy.

In addition, other functions in the above third embodiment may also be stored in the memory 710 in a form of programs, and read and executed by the processor 720. Details of a control process have been described in the third embodiment in detail, and the same applies to the present embodiment. Details thereof are not repeatedly described herein.

Furthermore, as shown in FIG. 7, the electronic device 700 may further include a communication component 730, a power source component 740, an audio component 750, a display 760, and other components. Only a portion of the components are schematically illustrated in FIG. 7, and it is not meant that the electronic device includes only the components shown in FIG. 7.

The communication component 730 is configured to facilitate wired or wireless communications between the electronic device and other devices. The electronic device can access a wireless network based on a communication standard such as WiFi, 2G or 3G, or a combination thereof. In an exemplary embodiment, the communication component 730 receives broadcast signals or broadcast related information from an external broadcast management system via a broadcast channel. In an exemplary embodiment, the communication component 730 also includes a near field communication (NFC) module to facilitate short range communication. For example, the NFC module can be implemented based on radio frequency identification (RFID) technology, infrared data association (IrDA) technology, ultra-wideband (UWB) technology, Bluetooth (BT) technology, and other technologies.

The power source component 740 provides power to various components of the electronic device. The power component 740 can include a power management system, one or more power sources, and other components associated with generating, managing, and distributing power for the electronic device.

The audio component 750 is configured to output and/or input audio signals. For example, the audio component 750 includes a microphone (MIC) that is configured to receive an external audio signal when the electronic device is in an operational mode, such as a call mode, a recording mode, and a voice recognition mode. The received audio signal may be further stored in the memory 710 or transmitted via the communication component 730. In some embodiments, the audio component 750 also includes a speaker for outputting audio signals.

The display 760 includes a screen. The screen may include a liquid crystal display (LCD) and a touch panel (TP). If the screen includes a touch panel, the screen can be implemented as a touch screen to receive input signals from a user. The touch panel includes one or more touch sensors to sense touches, swipes, and gestures on the touch panel. A touch sensor can sense not only boundaries of a touching or swiping action, but also a time duration and a pressure associated with a touching or swiping operation.

One skilled in the art can understand that all or some of the steps of implementing the above method embodiments may be performed by hardware related to program instructions. The aforementioned program can be stored in a computer readable storage media. The program, when executed, performs the steps including the foregoing method embodiments. The foregoing storage media includes various media that can store program codes, such as a ROM, a RAM, a magnetic disk, or an optical disk.

Finally, it should be noted that the above embodiments are merely illustrative of the technical solutions of the present disclosure, and are not intended to be limiting. Although the present disclosure has been described in detail with reference to the foregoing embodiments, one of ordinary skill in the art should understand that the technical solutions described in the foregoing embodiments may be modified, or some or all of the technical features may be equivalently replaced. These modifications or replacements do not cause the essence of technical solutions to depart from the scope of the technical solutions of various embodiments of the present disclosure.

The present disclosure can further be understood using the following clauses.

Clause 1: A data processing method comprising: obtaining a question for an application environment; separately inputting the questions into a plurality of different types of question-and-answer models for processing to generate respective intermediate answers corresponding to each model, wherein the plurality of different types of question-and-answer models separately possess model data conforming to respective data forms, the model data is any number of pieces of structured data, semi-structured data, and unstructured data; and processing the intermediate answers generated for each model to generate and output a final answer based on a preset answer output strategy.

Clause 2: The method of Clause 1, wherein the plurality of different types of question-and-answer models comprise any ones of a knowledge map model, a FAQ model, and a machine reading comprehension model, model data of the knowledge map model being the structured data, model data of the FAQ model being the semi-structured data, and model data of the machine reading comprehension model being unstructured data.

Clause 3: The method of Clause 2, wherein: the model data of the knowledge map model comprises a knowledge base that is constructed based on a triplet format and a map structure formed by establishing relationships between entities based on attributes, and inputting the question into the knowledge map model for processing to generate an intermediate answer corresponding to the knowledge map model comprises performing structured processing on the question to extract entity or attribute information, which is inputted into a question structured search engine in the knowledge map model for searching to obtain an attribute corresponding to the entity or an attribute value corresponding to the attribute information, and setting a knowledge point corresponding to the attribute or attribute value as the intermediate answer outputted by the knowledge map model; and/or the model data for the FAQ model comprises question/answer pairs with an inverted index that is built on questions, and inputting the question into the FAQ model for processing to generate an answer corresponding to the FAQ model comprises inputting the question into a FAQ question search engine in the FAQ model to search for the answer, generating an order of answers of similar questions, and selecting an answer of a similar question having the highest ranking as an intermediate answer outputted by the FAQ model; and/or the model data of the machine reading comprehension model comprises a plurality of pieces of second text data having indices according to topics and/or paragraphs, and inputting the question into the machine reading comprehension model for processing to generate an answer corresponding to the machine reading comprehension model comprises inputting the question into a document search engine in the machine reading comprehension model for searching, determining second textual data related to the question through an index of topics and/or segments, treating the question as an input to a process of machine reading comprehension, and performing machine reading processing on the second text data to generate an intermediate answer as an output of the machine reading comprehension model.

Clause 4: The method of Clause 2, wherein processing the intermediate answers generated for each model to generate and output the final answer based on the preset answer output strategy comprises: outputting the intermediate answers generated by each model directly as the final answer for output; and/or performing confidence-based scoring on the intermediate answers generated by each model, and selecting an intermediate answer having a highest score as the final answer for output; and/or performing coverage analysis of text content of the intermediate answers generated by each model, and selecting text content having the highest coverage rate as the final answer for output.

Clause 5: The method of Clause 2, wherein after obtaining the question for the application environment, the method further comprises normalizing the question to enable the question to be adapted to input format requirements of any models of the knowledge map model, the FAQ model, and the machine reading comprehension model.

Clause 6: The method of Clause 2, wherein prior to obtaining the question for the application environment, the method further comprises: obtaining first text data in the application environment, classifying the first text data, and extracting any number of pieces of data in the structured data, the semi-structured data, and the unstructured data; and separately processing the any number of pieces of data in the structured data, the semi-structured data, and the unstructured data according to data format requirements of any multiple models of the knowledge map model, the FAQ model, and the machine reading comprehension model, model data of the knowledge map model to generate the model data of each model and storing the model data of each model.

Clause 7: The method of Clause 6, wherein: processing the structured data according to data format requirements of the knowledge map model to generate model data of the knowledge map model comprises processing the structured data into a knowledge base that is constructed based on a triplet format and a map structure formed by establishing relationships between entities based on attributes; and/or processing the semi-structured data according to data format requirements of the FAQ model to generate model data of the FAQ model comprises performing text clustering on answers in the semi-structured data to obtain multiple expressions of questions in the semi-structured data, constructing an inverted index based on the questions, and generating question/answer pairs having the inverted index based on construction of the questions; and/or processing the semi-structured data according to data format requirements of the machine reading comprehension model to generate model data of the machine reading comprehension model comprises dividing the unstructured data into a plurality of pieces of second text data according to topics and/or paragraphs, and creating an index according to the topics and/or the paragraphs.

Clause 8: The method of Clause 1, wherein the model data is obtained from extraction and processing of first text data of the application environment.

Clause 9: A data processing method comprising: obtaining first text data in the application environment, classifying the first text data, and extracting any number of pieces of data in the structured data, the semi-structured data, and the unstructured data; and separately processing the any number of pieces of data in the structured data, the semi-structured data, and the unstructured data according to data format requirements of appropriate question-and-answer models to generate the model data of each model and storing the model data of each model.

Clause 10: The method of Clause 9, wherein separately processing the any number of pieces of data in the structured data, the semi-structured data, and the unstructured data according to data format requirements of appropriate question-and-answer models to generate the model data of each model comprises separately processing the any number of pieces of data in the structured data, the semi-structured data, and the unstructured data according to data format requirements of any multiple models of a knowledge map model, a FAQ model, and a machine reading comprehension model, model data of the knowledge map model to generate the model data of each model and storing the model data of each model.

Clause 11: The method of Clause 10, wherein: processing the structured data according to data format requirements of the knowledge map model to generate model data of the knowledge map model comprises processing the structured data into a knowledge base that is constructed based on a triplet format and a map structure formed by establishing relationships between entities based on attributes; and/or processing the semi-structured data according to data format requirements of the FAQ model to generate model data of the FAQ model comprises performing text clustering on answers in the semi-structured data to obtain multiple expressions of questions in the semi-structured data, constructing an inverted index based on the questions, and generating question/answer pairs having the inverted index based on construction of the questions; and/or processing the semi-structured data according to data format requirements of the machine reading comprehension model to generate model data of the machine reading comprehension model comprises dividing the unstructured data into a plurality of pieces of second text data according to topics and/or paragraphs, and creating an index according to the topics and/or the paragraphs.

Clause 12: A data processing apparatus comprising: a question acquisition module configured to obtain a question for an application environment; a model processing module configured to separately input the questions into a plurality of different types of question-and-answer models for processing to generate respective intermediate answers corresponding to each model, wherein the plurality of different types of question-and-answer models separately possess model data conforming to respective data forms, the model data is any number of pieces of structured data, semi-structured data, and unstructured data; and an answer output module configured to process the intermediate answers generated for each model to generate and output a final answer based on a preset answer output strategy.

Clause 13: The apparatus of Clause 12, wherein the plurality of different types of question-and-answer models comprise any ones of a knowledge map model, a FAQ model, and a machine reading comprehension model, model data of the knowledge map model being the structured data, model data of the FAQ model being the semi-structured data, and model data of the machine reading comprehension model being unstructured data.

Clause 14: The apparatus of Clause 13, wherein processing the intermediate answers generated for each model to generate and output the final answer based on the preset answer output strategy comprises: outputting the intermediate answers generated by each model directly as the final answer for output; and/or performing confidence-based scoring on the intermediate answers generated by each model, and selecting an intermediate answer having a highest score as the final answer for output; and/or performing coverage analysis of text content of the intermediate answers generated by each model, and selecting text content having the highest coverage rate as the final answer for output.

Clause 15: A data processing apparatus comprising: an environment text acquisition module configured to obtain first text data in the application environment, classifying the first text data, and extracting any number of pieces of data in the structured data, the semi-structured data, and the unstructured data; and a model data generation module configured to separately process the any number of pieces of data in the structured data, the semi-structured data, and the unstructured data according to data format requirements of appropriate question-and-answer models to generate the model data of each model and store the model data of each model.

Clause 16: The apparatus of Clause 15, wherein separately processing the any number of pieces of data in the structured data, the semi-structured data, and the unstructured data according to data format requirements of appropriate question-and-answer models to generate the model data of each model comprises separately processing the any number of pieces of data in the structured data, the semi-structured data, and the unstructured data according to data format requirements of any multiple models of a knowledge map model, a FAQ model, and a machine reading comprehension model, model data of the knowledge map model to generate the model data of each model and storing the model data of each model.

Clause 17: An electronic device comprising: memory configured to store a program; and processor(s) coupled to the memory and configured to execute the program for: obtaining questions for an application environment; separately inputting the questions into a plurality of different types of question-and-answer models for processing to generate respective intermediate answers corresponding to each model, wherein the plurality of different types of question-and-answer models separately possess model data conforming to respective data forms, the model data is any number of pieces of structured data, semi-structured data, and unstructured data; and processing the intermediate answers generated for each model to generate and output a final answer based on a preset answer output strategy.

Clause 18: The electronic device of Clause 17, wherein the plurality of different types of question-and-answer models comprise any ones of a knowledge map model, a FAQ model, and a machine reading comprehension model, model data of the knowledge map model being the structured data, model data of the FAQ model being the semi-structured data, and model data of the machine reading comprehension model being unstructured data.

Clause 19: An electronic device comprising: memory configured to store a program; and processor(s) coupled to the memory and configured to execute the program for: obtaining first text data in the application environment, classifying the first text data, and extracting any number of pieces of data in the structured data, the semi-structured data, and the unstructured data; and separately processing the any number of pieces of data in the structured data, the semi-structured data, and the unstructured data according to data format requirements of appropriate question-and-answer models to generate the model data of each model and storing the model data of each model.

Clause 20: The electronic device of Clause 19, wherein separately processing the any number of pieces of data in the structured data, the semi-structured data, and the unstructured data according to data format requirements of appropriate question-and-answer models to generate the model data of each model comprises separately processing the any number of pieces of data in the structured data, the semi-structured data, and the unstructured data according to data format requirements of any multiple models of a knowledge map model, a FAQ model, and a machine reading comprehension model, model data of the knowledge map model.

What is claimed is:

1. A method implemented by one or more computing devices, the method comprising:
obtaining a question for an application environment;
separately inputting the questions into a plurality of different types of question-and-answer models for processing to generate respective intermediate answers corresponding to each model, wherein the plurality of different types of question-and-answer models separately possess model data conforming to respective data forms, the model data being any number of pieces of structured data, semi-structured data, and unstructured data; and
processing the intermediate answers generated for each model to generate and output a final answer based on a preset answer output strategy.

2. The method of claim 1, wherein the plurality of different types of question-and-answer models comprise any ones of a knowledge map model, a FAQ model, and a machine reading comprehension model, model data of the knowledge map model being the structured data, model data of the FAQ model being the semi-structured data, and model data of the machine reading comprehension model being unstructured data.

3. The method of claim 2, wherein the model data of the knowledge map model comprises a knowledge base that is constructed based on a triplet format and a map structure formed by establishing relationships between entities based on attributes, and inputting the question into the knowledge map model for processing to generate an intermediate answer corresponding to the knowledge map model comprises performing structured processing on the question to extract entity or attribute information, which is inputted into a question structured search engine in the knowledge map model for searching to obtain an attribute corresponding to the entity or an attribute value corresponding to the attribute information, and setting a knowledge point corresponding to the attribute or attribute value as the intermediate answer outputted by the knowledge map model.

4. The method of claim 2, wherein the model data for the FAQ model comprises question/answer pairs with an inverted index that is built on questions, and inputting the question into the FAQ model for processing to generate an answer corresponding to the FAQ model comprises inputting the question into a FAQ question search engine in the FAQ model to search for the answer, generating an order of answers of similar questions, and selecting an answer of a similar question having the highest ranking as an intermediate answer outputted by the FAQ model.

5. The method of claim 2, wherein the model data of the machine reading comprehension model comprises a plurality of pieces of second text data having indices according to topics and/or paragraphs, and inputting the question into the machine reading comprehension model for processing to generate an answer corresponding to the machine reading comprehension model comprises inputting the question into a document search engine in the machine reading comprehension model for searching, determining second textual data related to the question through an index of topics and/or segments, treating the question as an input to a process of machine reading comprehension, and performing machine reading processing on the second text data to generate an intermediate answer as an output of the machine reading comprehension model.

6. The method of claim 2, wherein processing the intermediate answers generated for each model to generate and output the final answer based on the preset answer output strategy comprises outputting the intermediate answers generated by each model directly as the final answer for output.

7. The method of claim 2, wherein processing the intermediate answers generated for each model to generate and output the final answer based on the preset answer output strategy comprises performing confidence-based scoring on the intermediate answers generated by each model, and selecting an intermediate answer having a highest score as the final answer for output.

8. The method of claim 2, wherein processing the intermediate answers generated for each model to generate and output the final answer based on the preset answer output strategy comprises performing coverage analysis of text content of the intermediate answers generated by each model, and selecting text content having the highest coverage rate as the final answer for output.

9. The method of claim 2, further comprising normalizing the question to enable the question to be adapted to input format requirements of any models of the knowledge map model, the FAQ model, and the machine reading comprehension model after obtaining the question for the application environment.

10. The method of claim 2, wherein prior to obtaining the question for the application environment, the method further comprises:
obtaining first text data in the application environment, classifying the first text data, and extracting any number of pieces of data in the structured data, the semi-structured data, and the unstructured data; and
separately processing the any number of pieces of data in the structured data, the semi-structured data, and the unstructured data according to data format requirements of any multiple models of the knowledge map model, the FAQ model, and the machine reading comprehension model, model data of the knowledge map model to generate the model data of each model and storing the model data of each model.

11. The method of claim 10, wherein processing the structured data according to data format requirements of the knowledge map model to generate model data of the knowledge map model comprises processing the structured data into a knowledge base that is constructed based on a triplet format and a map structure formed by establishing relationships between entities based on attributes.

12. The method of claim 10, wherein processing the semi-structured data according to data format requirements of the FAQ model to generate model data of the FAQ model comprises performing text clustering on answers in the semi-structured data to obtain multiple expressions of questions in the semi-structured data, constructing an inverted index based on the questions, and generating question/answer pairs having the inverted index based on construction of the questions.

13. The method of claim 10, wherein processing the semi-structured data according to data format requirements of the machine reading comprehension model to generate model data of the machine reading comprehension model comprises dividing the unstructured data into a plurality of pieces of second text data according to topics and/or paragraphs, and creating an index according to the topics and/or the paragraphs.

14. The method of claim 1, wherein the model data is obtained from extraction and processing of first text data of the application environment.

15. One or more computer readable media storing executable instructions that, when executed by one or more processors, cause the one or more processors to perform acts comprising:
obtaining first text data in the application environment, classifying the first text data, and extracting any number of pieces of data in the structured data, the semi-structured data, and the unstructured data; and
separately processing the any number of pieces of data in the structured data, the semi-structured data, and the unstructured data according to data format requirements of appropriate question-and-answer models to generate the model data of each model and storing the model data of each model.

16. The one or more computer readable media of claim 15, wherein separately processing the any number of pieces of data in the structured data, the semi-structured data, and the unstructured data according to data format requirements of appropriate question-and-answer models to generate the model data of each model comprises separately processing the any number of pieces of data in the structured data, the semi-structured data, and the unstructured data according to data format requirements of any multiple models of a knowledge map model, a FAQ model, and a machine reading comprehension model, model data of the knowledge map model to generate the model data of each model and storing the model data of each model.

17. The one or more computer readable media of claim 16, wherein:
processing the structured data according to data format requirements of the knowledge map model to generate model data of the knowledge map model comprises processing the structured data into a knowledge base that is constructed based on a triplet format and a map structure formed by establishing relationships between entities based on attributes; and/or
processing the semi-structured data according to data format requirements of the FAQ model to generate model data of the FAQ model comprises performing text clustering on answers in the semi-structured data to obtain multiple expressions of questions in the semi-structured data, constructing an inverted index based on the questions, and generating question/answer pairs having the inverted index based on construction of the questions; and/or
processing the semi-structured data according to data format requirements of the machine reading comprehension model to generate model data of the machine reading comprehension model comprises dividing the unstructured data into a plurality of pieces of second text data according to topics and/or paragraphs, and creating an index according to the topics and/or the paragraphs.

18. An apparatus comprising:
one or more processors;
memory;
a question acquisition module stored in the memory and executable by the one or more processors to obtain a question for an application environment;
a model processing module stored in the memory and executable by the one or more processors to separately input the questions into a plurality of different types of question-and-answer models for processing to generate respective intermediate answers corresponding to each model, wherein the plurality of different types of question-and-answer models separately possess model data conforming to respective data forms, the model data is any number of pieces of structured data, semi-structured data, and unstructured data; and
an answer output module stored in the memory and executable by the one or more processors to process the intermediate answers generated for each model to generate and output a final answer based on a preset answer output strategy.

19. The apparatus of claim 18, wherein the plurality of different types of question-and-answer models comprise any ones of a knowledge map model, a FAQ model, and a machine reading comprehension model, model data of the knowledge map model being the structured data, model data of the FAQ model being the semi-structured data, and model data of the machine reading comprehension model being unstructured data.

20. The apparatus of claim 19, wherein processing the intermediate answers generated for each model to generate and output the final answer based on the preset answer output strategy comprises:
outputting the intermediate answers generated by each model directly as the final answer for output; and/or
performing confidence-based scoring on the intermediate answers generated by each model, and selecting an intermediate answer having a highest score as the final answer for output; and/or
performing coverage analysis of text content of the intermediate answers generated by each model, and selecting text content having the highest coverage rate as the final answer for output.
